(19) United States
(12) Patent Application Publication
(10) Pub. No.: US 2010/0244647 A1
(43) Pub. Date: Sep. 30, 2010

(54) High-Pressure Discharge Lamp

(75) Inventors: Joachim Arndt, Brieselang (DE); Uwe Fidler, Berlin (DE); Karen Twesten, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/682,904

(22) PCT Filed: Oct. 19, 2007
(86) PCT No.: PCT/EP2007/061209

§ 371 Date: Apr. 14, 2010

(51) Int. Cl. H01J 61/52; H01J 61/36

(52) U.S. Cl. 313/11; 313/624

(57) ABSTRACT

A high-pressure discharge lamp may include a ceramic elongated discharge vessel with a central part and two ends and an axis, the ends being sealed by means of seals, electrodes, which extend into the discharge volume enveloped by the discharge vessel, being anchored in the seals at leadthroughs, and the leadthroughs being sealed in the seal by means of glass solder, and a fill being accommodated in the discharge volume, wherein a cover rests on at least one end of a seal, which has a hollow-cylindrical body which is matched to the diameter of the seal, the cover covering at least exposed glass solder.

### TECHNICAL FIELD

The invention is based on a high-pressure discharge lamp in accordance with the precharacterizing clause of claim 1. Such lamps are in particular high-pressure discharge lamps with a ceramic discharge vessel for general lighting.

### PRIOR ART

U.S. Pat. No. 4,970,431 has disclosed a sodium high-pressure discharge lamp, in which the bulb of the discharge vessel is manufactured from ceramic. Fin-like protrusions used for heat dissipation are plugged onto the cylindrical ends of the discharge vessel.

EP-A 506 182 has disclosed coatings consisting of graphite or carbon or the like which are applied to ceramic discharge vessels at the ends in order to have a cooling effect.

A nitrogen fill in the outer bulb for reducing the temperature of the lamp in question is also known, see EP 581 423, for example. Photometric data are negatively influenced thereby, however.

### DESCRIPTION OF THE INVENTION

The object of the present invention is to provide a high-pressure discharge lamp, in which local heating of the discharge vessel is largely avoided.

This object is achieved by the characterizing features of claim 1.

Particularly advantageous configurations are given in the dependent claims.

The high-pressure discharge lamp is equipped with a ceramic elongated discharge vessel, usually consisting of Al₂O₃ or else AlN. The discharge vessel defines a lamp axis and has a central part and two end regions, which are each sealed by seals in the form of capillaries, electrodes, which extend into the discharge volume enveloped by the discharge vessel, being anchored in the seals. Preferably, the discharge volume also contains a fill with metal halides. This applies in particular to metal halide lamps which contains at least one of the halides of the rare earth metals, preferably one of the elements Dy, Ho, Tm, in particular together with Ce, in particular together with the halide of Na. In this case, color temperature fluctuations occur readily as a result of distillation effects.

Within reflector lamps, reflectors or else in narrow luminaires in which lamps with a base at one or two ends are used, or else in very compact lamps with an outer bulb, undesirable local temperature increases may arise as a result of back-reflection of radiation portions of specific components, for example of a cylindrical reflector neck region, onto the capillary of the discharge vessel. Damage to the sealing material, usually a glass solder, which seals the system including the ceramic capillary/electrode system may result. Fill constituents may emerge from the burner. According to the invention a cover is positioned onto the region where the glass solder is revealed on the outside for shielding purposes. The cover is preferably a sleeve or else a coating consisting of metal or metal oxide.

Since the radiation portion which is reflected back from the outside is shielded by the coating or sleeve, local heating of the fuse-seal zone can be avoided or reduced.

Specifically, the invention relates to a discharge lamp with a ceramic discharge vessel with capillaries, in which electrode systems are fuse-sealed. The length of the capillaries and the geometry of the discharge vessel can vary. The geometry of the discharge vessel can in this case be cylindrical, round, elliptical or the like.

A novel possibility for radiation shielding is the use of a sleeve consisting of ceramic, preferably consisting of steatite ceramic. It is shaped in such a way that it covers at least the entire fuse-seal region. This shielding sleeve is a hollow cylinder, which is turned back over the fuse-seal region of the ceramic capillary. The sleeve is prevented from sliding on the capillary by virtue of suitable measures which produce a holding mechanism, for example flat pinch-sealing of the metallic power supply line, welding of the stop wire etc. Preferably, the shielding sleeve has a bottom which covers the glass solder. However, it can also be extended to a sufficient extent only beyond the end of the capillary, in a simpler manner.

In particular, in addition a high-temperature-resistant, preferably ceramic coating can be applied to the fuse-seal zone of the burner capillary, as is known per se. Particularly well suited is zirconium oxide or another metal oxide. EP-A 506 182 has disclosed coatings consisting of graphite or carbon or the like which are applied to ceramic discharge vessels at the ends in order to have a cooling effect. The application of the coating can take place by means of vapor deposition, atomization, immersion, daubing etc. The layer has good reflection properties in the visible and infrared radiation ranges. A highly reflective, metallic coating is likewise conceivable, however. The position of the coating can extend over the entire fuse-seal region of the capillary, or else be applied in segmented fashion.

The wall thickness d of the shielding sleeve is between 0.5 and 2 mm. The outer diameter results correspondingly. The length L of the sleeve is preferably from 1 to 1.3 times the fuse-seal zone.

In principle, other materials than steatite ceramic are also conceivable. The sleeve is preferably simply in the form of a cylinder. However, other embodiments can also be used. One possible variant embodiment may be a temperature-stable, preferably ceramic sleeve provided on the outside with ribs and/or webs. In this case, the arrangement of these ribs or webs can have an axial or else radial profile. The ribs or webs can be either continuous or in segmented form.

The number of ribs or webs is dependent on the diameter of the burner capillary or the sleeve and on the profile of the webs (axial or radial). In the case of an axial profile of the webs, the number is at least three webs, however. They are preferably distributed uniformly over the circumference. In the case of a radial profile of the webs, a gap of at least from one to three times the web width is preferred in relation to the neighboring web. The width of the web in the case of the axial profile is dependent on the outer diameter of the sleeve and on the number of webs, but is at least 0.5 mm. The depth of the webs is at least 0.5×d, at most 3×d (d is the wall thickness of the sleeve).

In this variant embodiment, a combination with a coating is also conceivable. The coating should be reflective. Suitable materials are in particular ZrO₂ or TiO₂, but metal layers which are resistant to high temperatures are also conceivable. This coating can also be used per se on its own, i.e. without a sleeve, in particular by virtue of it covering the exposed meniscus of the glass solder.

A further possibility which is already known for reducing the temperature in the fuse-seal region is the introduction of the webs or ribs directly into the material of the burner ceramic; see WO2007082885. In this case, various geometries can likewise be used. One disadvantage is the fact that the glass solder on the outside cannot be covered by an integral web.

A modified capillary end geometry can result in a reduction in the capillary temperature in the fuse-seal zone.

In particular, the seals are advantageously in the form of capillaries. However, they can also have a different design; see DE-A 197 27 429, for example, in which a cermet pin is used.

The discharge vessel typically consists of aluminum-containing ceramic such as PCA or else YAG, AlN or AlYO₃. The choice of fill is not subject to any particular restrictions either.

### BRIEF DESCRIPTION OF THE DRAWINGS

The invention will be explained in more detail below with reference to a plurality of exemplary embodiments. In the figures:

FIG. 1 shows a high-pressure discharge lamp with a discharge vessel;

FIG. 2 shows a detail of the discharge vessel shown in FIG. 1;

FIGS. 3-4 show an exemplary embodiment of an end region of a discharge vessel;

FIGS. 5-6 each show a further exemplary embodiment of a discharge vessel.

### PREFERRED EMBODIMENT OF THE INVENTION

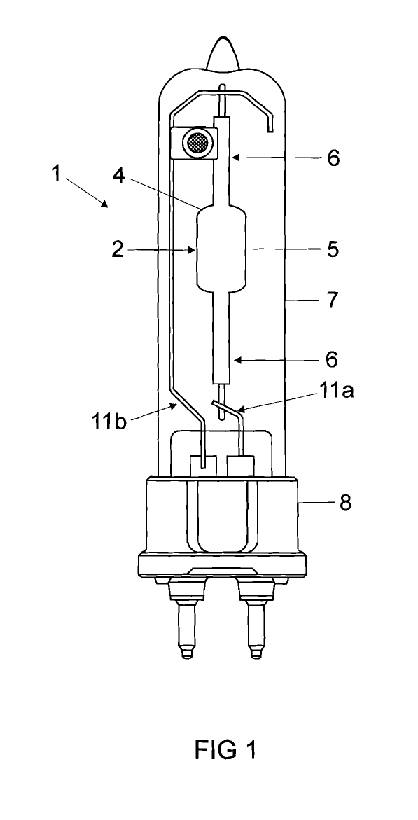

FIG. 1 shows a schematic of a metal halide lamp 1. It includes a tubular discharge vessel 2 consisting of ceramic, into which two electrodes are introduced (not shown). The discharge vessel has a central part 5 and two ends 4. Two seals 6, which are in this case in the form of capillaries, rest on the ends. Preferably, the discharge vessel and the seals are produced integrally from one material such as PCA.

The discharge vessel 2 is surrounded by an outer bulb 7, which is terminated by a base 8. The discharge vessel 2 is held in the outer bulb by means of a frame, which contains a short and a long power supply line 11a and 11b.

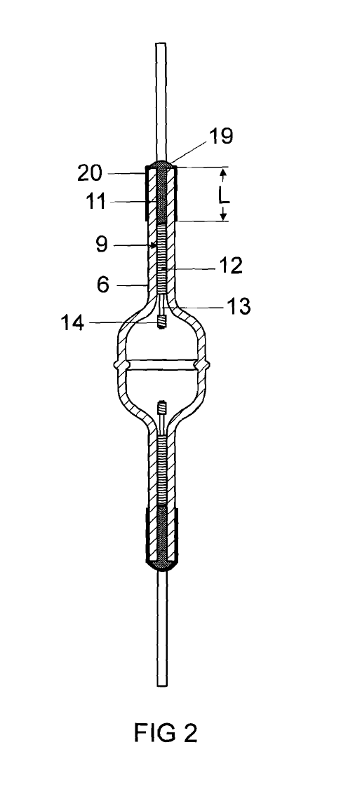

FIG. 2 shows a detail of a discharge vessel. A leadthrough 9 consisting of a plurality of parts rests in the capillary 6, as is known per se. Said leadthrough is in the form of an Mo bar 11, with an Mo filament 12 being applied in the front half thereof in order to minimize the gap with respect to the capillary. The shaft 13 of the electrode 14 rests at the front on the Mo bar. A glass solder 19, which forms a meniscus towards the outside, is used for sealing purposes at the end of the capillary. The glass solder in this case runs into the capillary, for example as far as the point at which the Mo filament 12 begins. This region is denoted as the sealing length L.

The shield should now be fitted in such a way that it, if possible, protects the sealing length and the glass solder positioned on the outside. In principle, as is shown below in FIG. 2, even a coating 20 is suitable for this purpose, said coating firstly shielding the sealing length L and in addition also the glass solder 19 on the outside. Said coating is manufactured from a highly thermally resistant metal oxide such as zirconium oxide or titanium oxide or aluminum oxide, as is known per se.

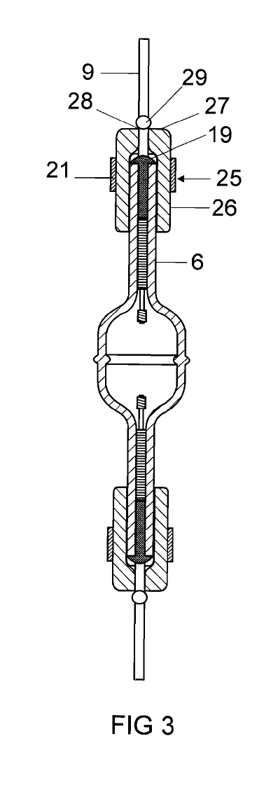

FIG. 3 shows an end region, in which a shielding sleeve 25 has been plugged onto the end of the capillary 6. The sleeve 25 has a hollow-cylindrical body 26, which is matched, from the outside, approximately to the diameter of the capillary. In addition, the sleeve 25 has a bottom part 27, which seals the body 26 with respect to the outside and therefore covers the glass solder 19 which is on the outside. In order that it can be threaded onto the leadthrough 9, the bottom has a central bore 28. The sleeve can itself be surrounded by a coating 21, as specified above, which preferably extends over the body and the bottom or else only over the body or a part thereof. The sleeve is held by virtue of flat pinch-sealing 19 of the leadthrough 9 or the like. The sleeve should cover at least the sealing length L of the glass solder.

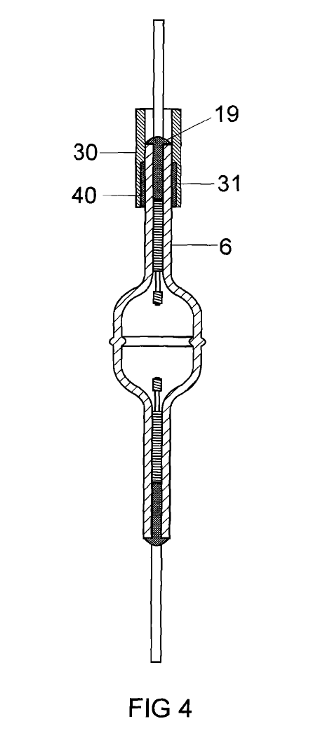

FIG. 4 shows a simple version of the sleeve 30 in which no bottom is provided. Shielding of the glass solder 19 positioned on the outside is achieved by virtue of the fact that the hollow cylinder is extended beyond the glass solder and thus provides shading with respect to incident radiation. In this case, the sleeve should be fastened on the capillary by means of adhesive or fused ceramic 40 or the like. For this purpose, it is recommended to provide channels 31 for accommodating the adhesive on the inner wall of the sleeve.

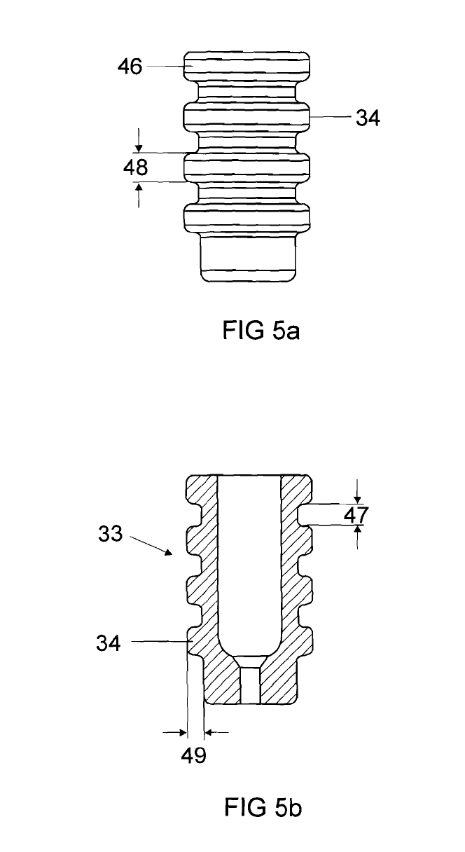

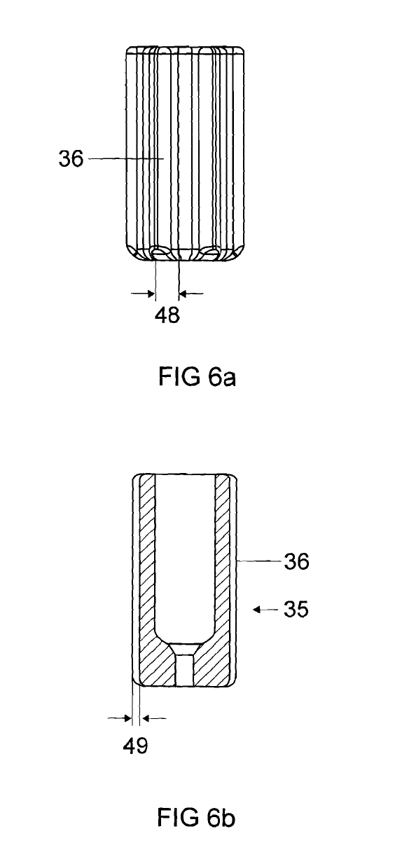

FIG. 5 shows a sleeve 33 which has been provided with radial ribs 34 in order to improve the emission of heat. FIG. 6 shows a sleeve 35, which has been provided with axial webs 36 in order to improve the emission of heat. In this case, too, a coating is additionally possible. The number of ribs or webs is dependent on the diameter of the burner capillary or the sleeve and on the profile of the webs (axial or radial). In the case of an axial profile of the webs, the number of webs which are distributed uniformly over the circumference is at least three, however. In the case of a radial profile of the webs, a gap 47 of at least 1-3 times the web width is provided with respect to the neighboring web. The width 48 of the webs in the case of the axial profile is dependent on the outer diameter of the sleeve and on the number of webs, but is a minimum of 0.5 mm. The depth 49 of the webs is a minimum of 0.5×d, a maximum of 3×d (wall thickness of sleeve). LX is the total length of the sleeve.

The point of attachment, wall thickness and height of the cooling ring can be used to adjust the cooling effect on the surface zone of the burner vessel locally and to adapt it to the respective requirements.

The point of attachment of the sleeve, the wall thickness and the length of the sleeve as well as the thickness of the bottom can be used to optimize the thermal capacity.

1. A high-pressure discharge lamp, comprising:
a ceramic elongated discharge vessel with a central part and two ends and an axis, the ends being sealed by means of seals, electrodes, which extend into the discharge volume enveloped by the discharge vessel, being anchored in the seals at leadthroughs, and the leadthroughs being sealed in the seal by means of glass solder, and
a fill being accommodated in the discharge volume,
wherein a cover rests on at least one end of a seal which has a hollow-cylindrical body which is matched to the diameter of the seal, the cover covering at least exposed glass solder.

2. The high-pressure discharge lamp as claimed in claim 1, wherein the seal is in the form of a capillary.

3. The high-pressure discharge lamp as claimed in claim 1, wherein the sleeve protrudes outwards beyond the seal to such an extent that it acts as shading means for the glass solder located on the outside.

4. The high-pressure discharge lamp as claimed in claim 1, wherein the sleeve is sealed off from the outside by means of a bottom.

5. The high-pressure discharge lamp as claimed in claim 1, wherein the sleeve is manufactured from ceramic.

6. The high-pressure discharge lamp as claimed in claim 1, wherein in that the sleeve has ribs or webs on the outside for improving the cooling effect.

7. The high-pressure discharge lamp as claimed in claim 1, wherein the sleeve is additionally provided at least partially with a heat-reflective coating.

8. The high-pressure discharge lamp as claimed in claim 1, wherein the cover is realized by a coating consisting of metal oxide.

9. The high-pressure discharge lamp as claimed in claim 1, wherein the fill contains metal halides.

10. The high-pressure discharge lamp as claimed in claim 1, wherein the cover rests on a separate sleeve

11. The high-pressure discharge lamp as claimed in claim 1, wherein the cover also covers a further region of the seal which contains glass solder.

12. The high-pressure discharge lamp as claimed in claim 5, wherein the sleeve is manufactured from steatite.

13. The high-pressure discharge lamp as claimed in claim 1, wherein the cover is realized by a coating consisting of metal.
